(19) United States
(12) Patent Application Publication
(10) Pub. No.: US 2009/0171789 A1
(43) Pub. Date: Jul. 2, 2009

(54) Method and System for Managing and Trading Web-Based Virtual Services

(75) Inventor: Yuanhua Tang, San Jose, CA (US)

Correspondence Address: Yuanhua Tang, 1147 Huntingdon Dr, San Jose, CA, 95129, US

(73) Assignee: Ikain, Inc, San Jose, CA (US)

(21) Appl. No.: 12/342,035

(22) Filed: Dec. 22, 2008

Related U.S. Application Data
(60) Provisional application No. 61/009,048, filed on Dec. 26, 2007.

(51) Int. Cl. G06Q 30/00; G06Q 10/00; G06F 15/16; G06Q 20/00

(52) U.S. Cl. 705/14; 709/206; 705/26

(57) ABSTRACT

Virtual services are works that can be carried out without physical presence. This invention relates to a method and a system that allows subscribers of the system to manage and trade virtual services over a wide area network, such as the Internet. Subscribers can advertise and provide virtual services through this system. They also search the virtual services and schedule appointments. The virtual services can be conducted through virtual offices provided in this system. Virtual offices can be used alone to perform advertising tasks, where users can search for products and services and talk to the advertisers directly through online media.

### BACKGROUND

1. Field of Invention

This invention relates to a method and a system that allow subscribers of the system to trade virtual services over a wide area network, such as the Internet.

2. Background

Virtual services are services that can be carried out without meeting in person of the virtual services providers and virtual service customers. They can be delivered through online communication media such as emails, instant-messages, voice instructions, and video images . For example, a person can call a telephone number and receive advices. A bank teller can perform transactions based on client's request remotely. A security personnel can remotely monitor the safety of a neighborhood, a checkpoint, a house, a bank, or an ATM machine through video cameras. A teacher can give lectures remotely to one or more students. A tutor can answer questions and exchange ideas with a student via the Internet. Some educational websites provide capacity for teachers to enroll students and start on-line classes. Remote monitoring of patients, children, and prisoners are also virtual services.

Virtual services seen today are only a small portion of such services possible. As we step further into the information age, virtual jobs will increase dramatically. Many tasks that do not require physical presence will gradually turn virtual. The reasons for such a transition many, some of which include: (1) virtual implementation frees people from the limit of space so employer will be able to hire talents world-wide; (2) virtual jobs are environmentally friendly as it requires no travel; (3) virtual jobs can reduce the cost of service substantially, as services in remote regions can be much cheaper; (4) virtual jobs also mean higher quality services for any possible tasks, since the best match for any job is almost always non-local; (5) virtual market enables employers to find the rare talents, any where possible.

Even though there is a high demand for virtual services, there is no media for the open and fair trading of such services today. There are several methods and arrangements for people to provide services by using Internet. But these methods and arrangements are all inadequate in providing robust scheduling, trading, and delivering of virtual services.

Craigslist.com is a central network of online communities, featuring free online classified advertisements of jobs, internships, housing, personals, resumes, erotic services and goods for sale. It also provides for discussion forums on various topics. Craigslist.com services are like classified ads, arranged primarily by locations and categories. They are mainly for people to trade goods or services locally. Users can register accounts at craigslist.com, set up advertisements, or search for the advertisements. Craigslist.com, however, does not provide scheduling of events, calendar, chat room/virtual offices, service feedback, money transactions, or online accounting.

eBay.com is an online auction and shopping website in which people and businesses buy and sell goods and services worldwide. It provides an auction scheme where people can auction and bid for items. Individuals can set up their virtual stores on eBay to sell their products. Others can come and search for products and make purchases and payments. However, eBay's are mostly used for trading commodities instead of virtual services. There is no support of events scheduling and virtual offices on eBay.com.

Skype is a peer-to-peer (P2P) software package that allows users to make telephone calls over the Internet. P2P means that each computer acts as a server to the other, and there is no dedicated server that mediates the communication between the two peers. Calls to other users of the service and to free-of-charge numbers are free, while calls to landlines and mobiles phones can be made for a fee. Additional features include instant messaging, file transferring, and recently added video conferencing. However, because Skype programs are based on the P2P protocol, users have to install the Skype software, and can only communicate with another user who has installed the same software. This greatly limits its use in comparison to software packages that run directly from the Internet. In addition, Skype does not allow a virtual service provider to advertise the services to the whole online community. Neither does it provide a scheduling module or a feed back mechanism.

There is a need for virtual services providers and customers to conduct business online without the constraint of physical locations. There is also a need of Internet-based software where users can advertise, search, schedule, rate, comment on, and carry out virtual services. Furthermore, there is a need of a one-stop shop where all the functions associated with virtual services are assembled and integrated coherently together for the convenient use of the public.

### BRIEF SUMMARY

In one aspect, an embodiment of the present invention relates to a method of providing online virtual offices to online virtual service providers to enable them to conduct services among the community of subscribers, and said method comprising the steps of: online virtual service providers advertising their services online; online virtual services seekers searching the advertised services; and the service providers and service seekers conducting online virtual services through online virtual offices.

In another aspect, the present invention relates to a system for subscribed community members to provide virtual services to other subscribed community members, the system comprising: an online server having a registration routine for a person who has access to internet to register to the system from a local computer to become a subscriber of the system; said online server further having a storage routine to store information related to the subscriber or the virtual service provided by the subscribers; said online server further having an advertisement display routine to display and organize the virtual services provided by the subscribers; said online server further having a search routine for subscribers to search the virtual services provided by the subscribers; said online server further having a communication routine for the subscribers to conduct online virtual service in a virtual online office; said online server further having a client application routine, transferable via internet, allowing subscribers to access the functions of the online server.

In a further aspect, the present invention relates to a computer storage medium having data and instructions which will cause at least a portion of a computer system to perform the steps of: online virtual service providers advertising their services online; online virtual services seekers searching the advertised services; and the service providers and service seekers conducting online virtual services through online virtual offices.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 shows the steps of virtual services seekers take to find the virtual services.

FIG. 2 shows the web-based multimedia communication between users.

FIG. 3 shows one way used by the system users to transact business.

FIG. 4 shows the online server related to end users.

FIG. 5 describes one embodiment of the framework of the online server.

FIG. 6 describes two embodiments of the trading procedures.

FIG. 7 shows one example of the user interface with registration function.

FIG. 8 shows one example of the user interface for searching services.

FIG. 9 shows one example of the user interface to publish advertisements.

FIG. 10 shows one example of the user interface to publish calendar.

FIG. 11 shows one example of the user interface for listing reserved events.

FIG. 12 shows one example of the user interface used by the virtual offices.

FIG. 13 shows one example of the user interface used to perform slide shows .

FIG. 14 shows one example of the user interface for managing online transaction.

FIG. 15 shows one example of the database construct used in the system.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

The present invention is directed to an open, internet-based platform for delivering online services and its associated transactions. This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

Virtual offices, sometimes referred as online offices or web-based offices, are an environment that provides means for two or more people to interact with each other over a wide area network, such as internet, without being in physical presence of each other. The interaction can be through internet instant message, online phone exchange, real time video conferencing, etc. A virtual office is an online virtual environment, where users can enter and interact with others in this controlled, private environment. A typical virtual office environment supports online face-to-face conversation, slide show, instant messaging, etc.

Virtual services, sometimes referred as online virtual services, online services, virtual labor or virtual job, describe any services that are provided or delivered over a wide area network, such as internet, through online media including, not limited to, internet instant message, online phone exchange, and real time video conferencing.

Virtual services providers are people who provide virtual services online. Virtual services seekers, sometimes referred as virtual services customers or virtual services clients are people who search or use the virtual services provided online by the providers.

Online server includes a variety of software routines located on one or more computers that are connected to a Wide Are Network, such as Internet. These software routines can be used to provide services to individual users of the online server. It can also be used to maintain a system, of which the online server is a part.

Services database is a collection of information concerning users. This database includes tables that are integrated together using the relational database schema. Some example include the profile table of the users; table of the services provided or sought; the preferences about user's settings such as time-zones and currency; the calendar table showing the availability of each user; the account table where users' account balance and payment information is stored.

Full text search is a search method where the entire context of the collection is searched. The targets of the search can be user profiles, service descriptions, messages, and/or forums. A user can enter a few keywords for the search, or some descriptions. The internal engine then performs the full text search, and reports hits found in a ranked way.

Description database of virtual services is a collection of database tables concerning the virtual services users are providing (from providers) or seeking (from seekers). Each service provided or sought should have a title, a detailed description which many contain subtitles and section heads, and pictures supporting the theme of the service, and associated information such as contact info, available hours, and a web address.

Web-based multimedia communication includes many distinct modes of communication. The most basic ones are audio communication (talking to each other or holding conferences), audio and video communication where image of users are communicated as well, instant messaging where users can type and display in other's screen text message, file transferring where files are exchanged between users, slide shows where one user serves as a host and displays picture/file screens on other users' computer screens, and messaging where text messages are sent via electronic mail boxes. Additional method of multimedia communication may include instant delivering of hand-writings, and drawings from one user to others using a specific software or with additional hardware attached to a computer. This method of communication may be called a “virtual white board”.

Escrow is a method of money transaction between providers and seekers mediated through an agent. The escrow agent in our case is a software module that interacts with other software module. Seekers make payment to service providers through an escrow account managed by the escrow agent, and providers collect payment from service seekers through escrow accounts managed by the escrow agent. The escrow agent guarantees that a seeker has sufficient fund to pay for the service before the service is delivered or at the time the service is reserved. It also guarantees the completion of such transaction when the service is completed as scheduled.

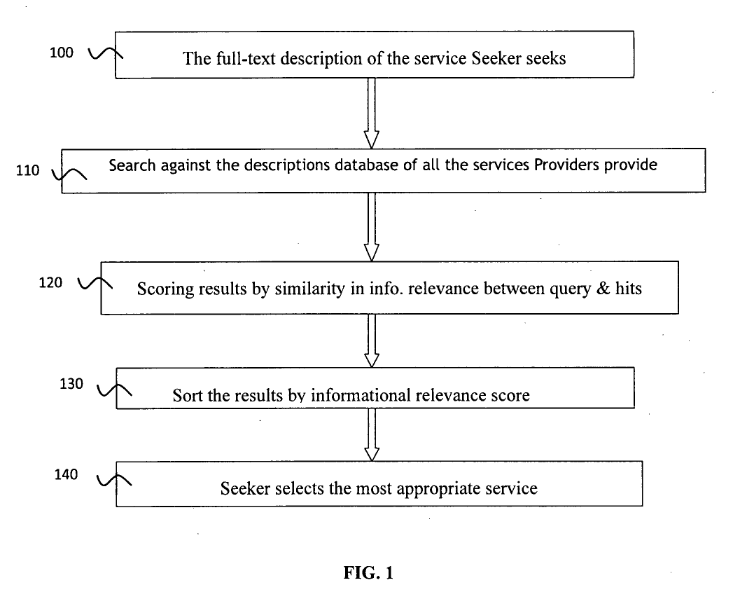

In one embodiment, a virtual service seeker can use full-text to search virtual services. FIG. 1 describes the process can be used by a virtual service seeker to search the virtual services. The seeker can put in a full text or keyword description 100, and search against the descriptions database of the virtual services provided 110. The results from the search are scored according to the similarity and/or relevance between the query and the hits 120. The results are then sorted according to the relevance score 130. The virtual service seeker can then select the services he(she) desires 140.

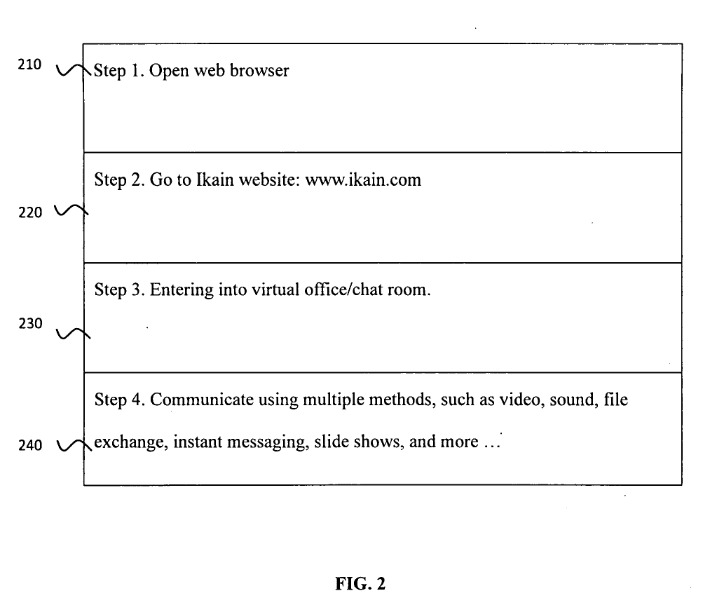

FIG. 2 shows a process for virtual service seekers and virtual service providers to communicate through web-based multimedia. A user first starts a web browser on his computer 210. In one embodiment, he can go to http://www.ikain.com 220, from where he can enter a chat room to meet with his prospective seeker(s) or provider 230. He then starts the service using a multitude of communication packages available at the chat room or virtual office 240.

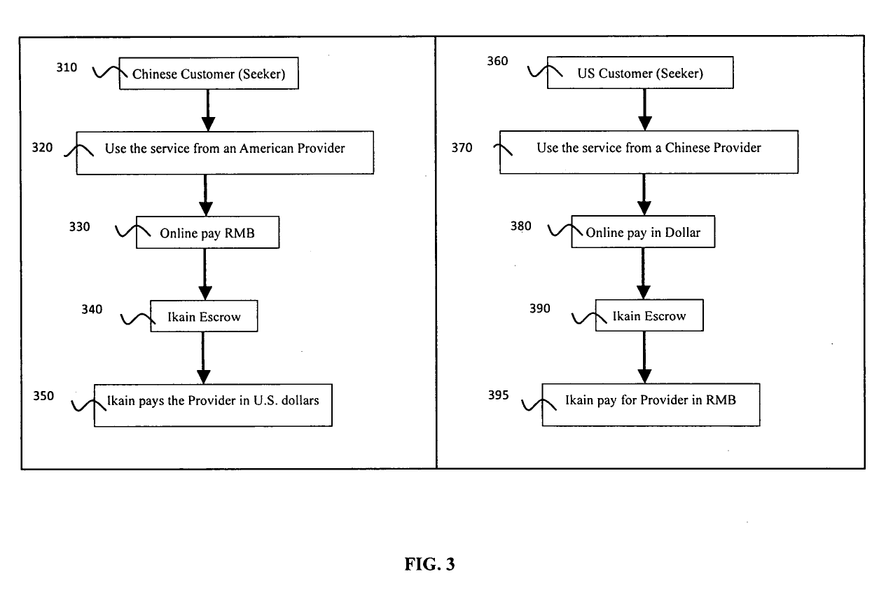

In one embodiment, the virtual services can be conducted internationally. The payment for such virtual services can be hold in an escrow. FIG. 3 illustrates a process that a virtual service seeker uses to pay the virtual services provided by the virtual service provider. For example, when a seeker uses a service from US, Ikain (host for www.Ikain.com), can act as an escrow agent and collect Chinese currency (RMB) from the seeker, and pay for the provider in U.S. dollars. For a seeker in US and the provider in China, the situation can be handled similarly. In one embodiment, a customer in China 310, can order a service that is provided by a person in U.S. 320 and pay for the service in RMB 330. Ikain escrow account can convert the money into US dollars, using a real-time quote as the conversion rate 340. Ikain can then deduct the exact amount of RMB from the seeker's account, and put the matching amount of US dollars on the provider's account 350.

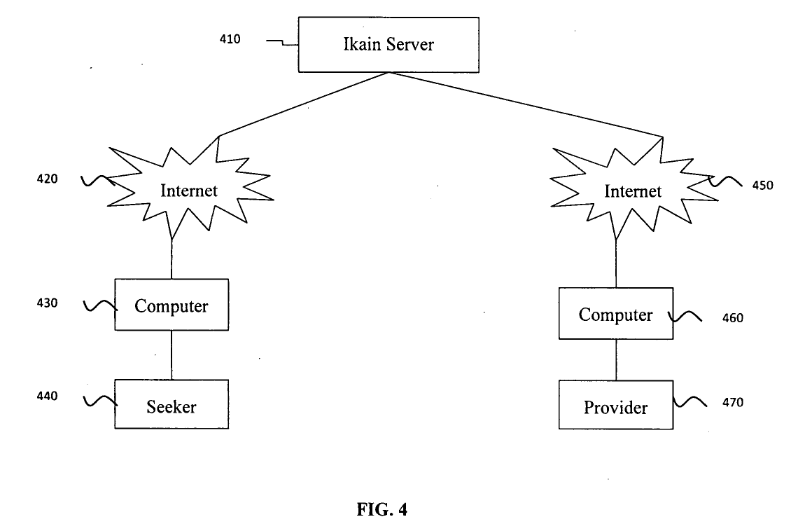

FIG. 4 shows how the online server related to end users in one embodiment. A remote service provider 470 and a seeker 440 go online by computer or portable computer 430, 460. Through their web browsers 420, 450, both users can reach to website located at an online server, such as Ikain data service center, by the Internet 410. In this way, real time communications between two users is achieved.

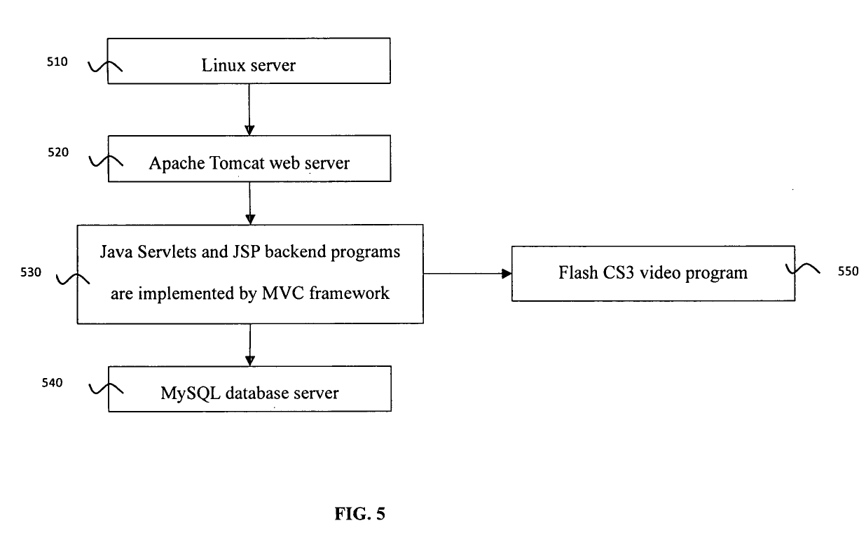

FIG. 5 describes one embodiment of the framework of the online server. Linux server 510, Apache Tomcat web server 520 and MySQL database server 540 can be used as basic framework. Java Servlets, JSP and Flash CS3 video programs can be used to complete the development of product 530, 550. A Linux server is a computer with Linux operating system, which is an open-source operating system that uses Unix-like kernel and follows the BSD (Berkeley Standard Distributions). Apache Tomcat is a servlet container developed by the Apache Software Foundation. Tomcat implements the Java Servlet and JavaServer Pages (JSP) with specifications from Sun Microsystems. It provides a “pure java” HTTP web server environment for Java code to run. Apache Tomcat includes tools for configuration and management, but can also be configured by editing configuration files that are XML-formatted. MySQL is a freely available open source relational database management system, a database engine that uses structured query language (SQL). Adobe FLASH CS3 is a multimedia platform created by Adobe Systems popular for adding animation and interactivity to web pages.

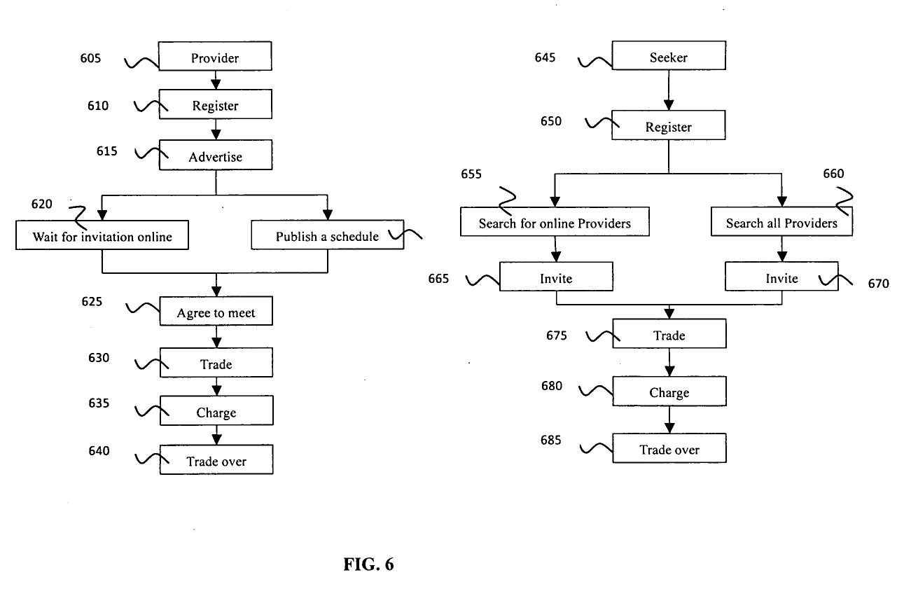

FIG. 6 describes two parallel processes in one embodiment for a trade of online service. A provider of the service 605 can first register 610 and then sets up his advertisement 615. Afterwards, he can follow two distinct modes to complete a trade: either wait for an invitation online at real time 620, or publish a schedule and wait for users to make reservations 622. After an agreement is reached 625, the trade starts 630. At the completion of the service, a charge is placed onto the seeker's account and transfer of money occurs 635. This transfer completes one instance of virtual service trade.

In one embodiment, a virtual service seeker needs first to register 650. Then he can search either for real-time services from those providers that are already online 655, or search all providers with active advertisements 660. An invitation can be sent to the provider 665, 670, and the trade of virtual service can then start and proceed to completion 675, 680, 685.

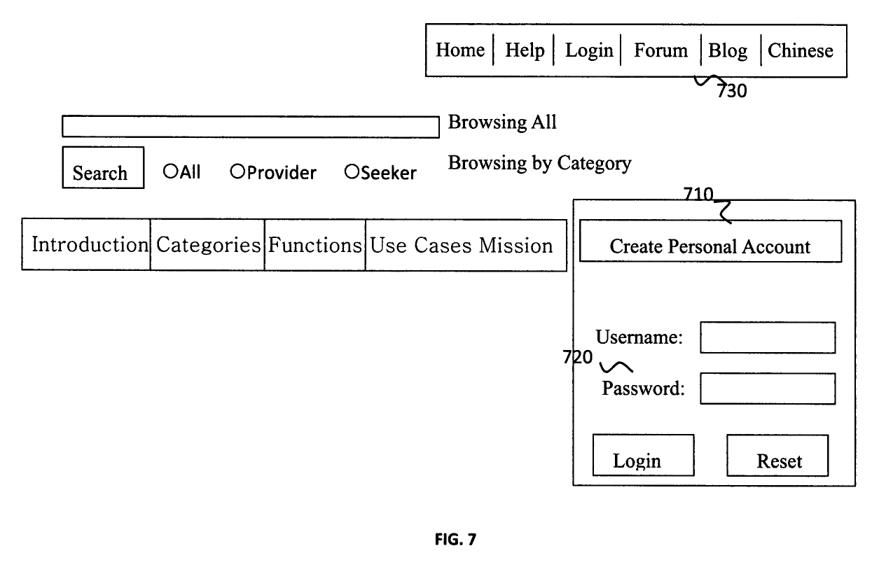

FIG. 7 shows one example of the user interface with registration function. Click at 710, one can start the registration process and create a user account. After the activation of the user account, he can login at 720. At 730, a user can switch between different languages, e.g., from English to Chinese.

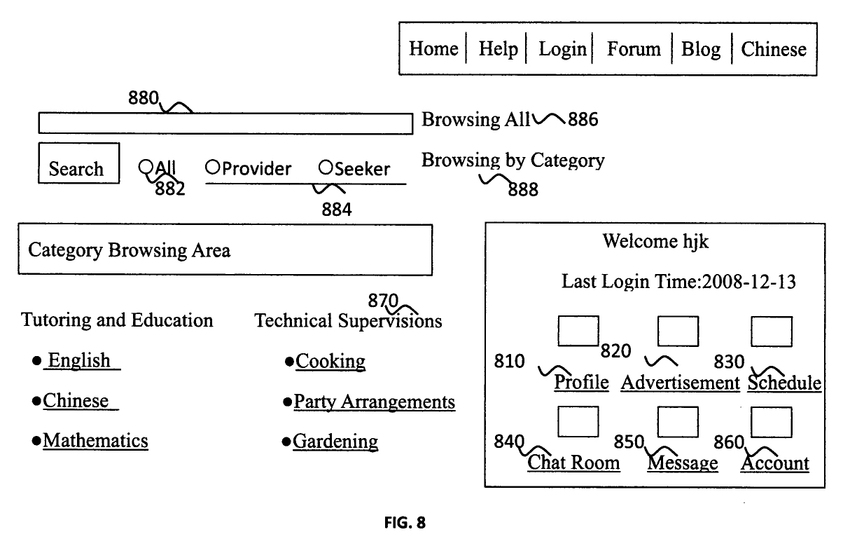

FIG. 8 shows one example of the user interface for searching services. From here, a user can go to other functional pages. For example, profile page 810 allows users to change settings such as time zone, currency type, language preference, etc. Advertisement page 820 allows users to advertise specific services he seeks or he provides. Schedule page 830 can be used to publish the availability of service providers or seekers and for them to make reservations. Chat Room page 840 let users meet online using a host of media: live or recorded videos, sound, instant messaging, file exchange, slide show, etc. Message page 850 allows users to communicate with each other using internal email. Account page 860 assist users in managing money and tracking transactions.

FIG. 8 shows another group of functional modules related to search. One way of classification of the services are seen in 870. Following the links user will be able to go to further classification hierarchy, and to individual advertisement (not shown here). In this example, search boxes are located above the classification 880. Users can put in query words, full-text, or keywords here. The search can be against the entire collection 882, the providers 884, or the seekers 884. Advanced search 886 allows users to specify more details such as price range, or places where keywords appear (in the title or advertisement), etc. “Browsing all” function 888 allows users to browse all the advertisements. In one embodiment, once on the search produces the results, the user can specify more sorting criteria such as by date, title, username, first name, last name, etc. “Browsing by category” function 890 allows users to make a selection of the categories.

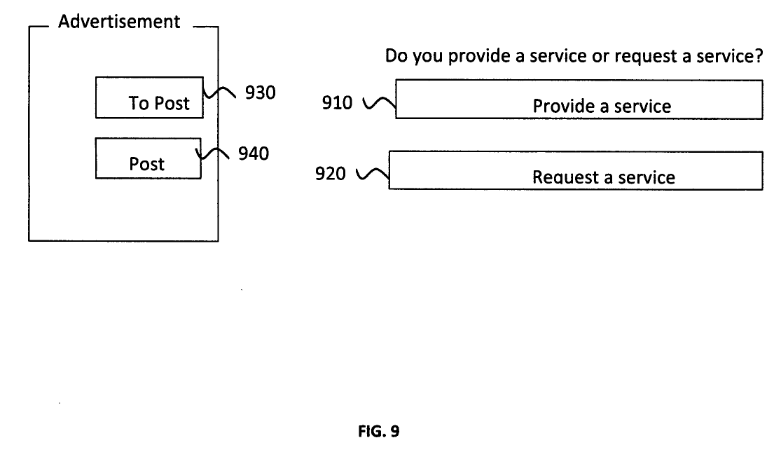

FIG. 9 describes one example of the user interface for publishing advertisements. A user can choose to publish an advertisement of a service 910, or to request a service 920. He can choose to post an advertisement 930; check on the list of advertisements he has set up 940; or revise the advertisements.

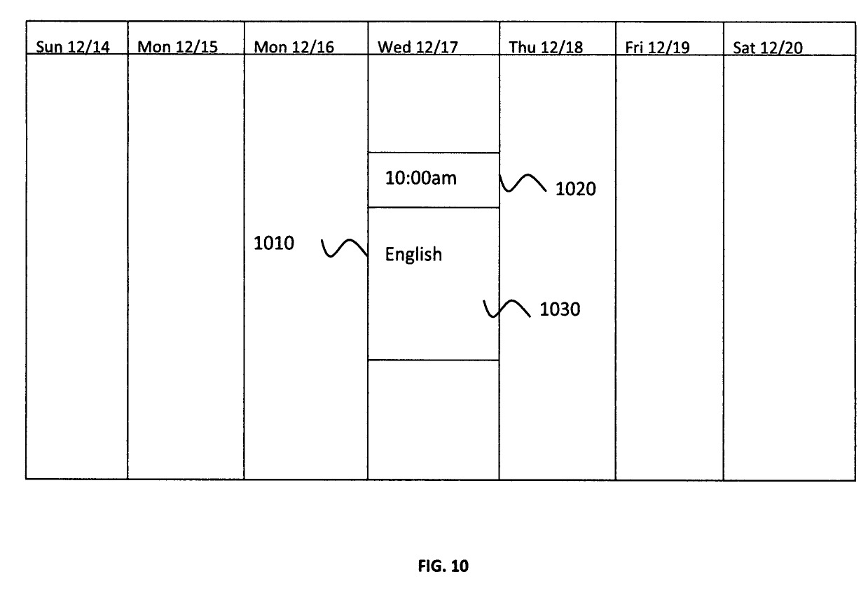

FIG. 10 shows one example of the user interface for publishing calendar. After publishing an advertisement, a user can add a schedule to it. The schedule will contain hours available for providing/receiving the specific advertised service 1010. The past time is darken out (dark gray in the figure). A new customer cannot make any reservation for these time slots. Deeper blue indicates the reserved time 1020 (black in the figure). The vertical direction shows the duration of the reservation. Lighter blue area indicates time slots where a new reservation can be selected for a certain specific advertised service 1030 (light gray in the figure).

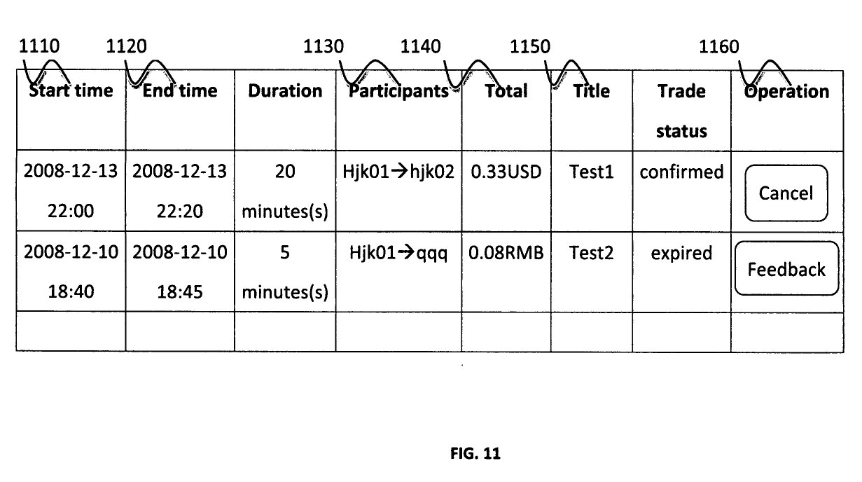

FIG. 11 shows one example of the user interface for listing reserved events. It includes the start and ending times 1110 & 1120, the participants 1130, the total cost 1140, the type of services involved 1150, and the operation the user wants to take 1160.

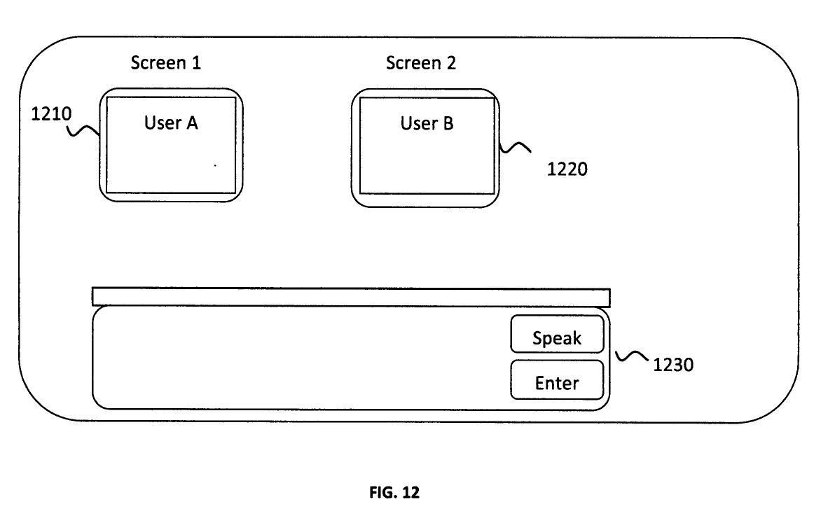

FIG. 12 shows one example of the user interface used by the virtual offices. Users can talk to another user or group of users face-to-face within the Chat room/virtual office. Here the video screens of a provider and a seeker are shown 1210, 1220. The sizes of these video screens are adjustable. In addition, users can exchange instant messages 1230.

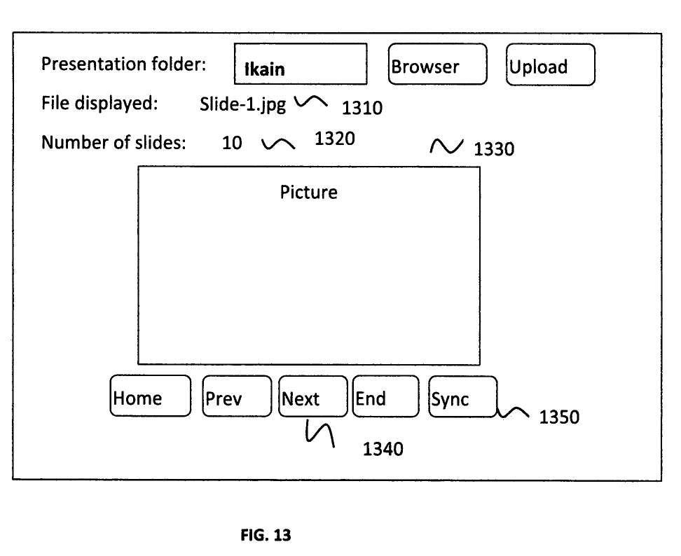

FIG. 13 shows one example of the user interface used by the virtual offices for performing slide shows. The file name is given at the top 1310, and the total number of slides involved 1320. In the middle is the slide itself 1330. The user can move backward or forward by clicking the lower buttons 1340. He can also request to be in sync with the other user who is having the meeting with him 1350.

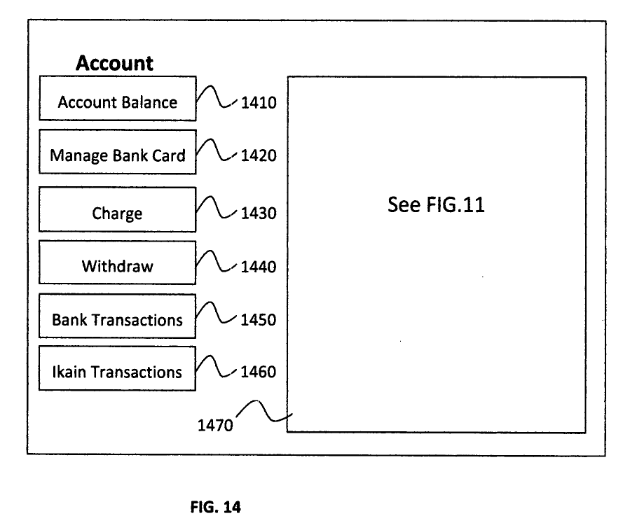

FIG. 14 shows one example of the user interface for managing online transaction. The account for the user to track his cash status and income/expenses. With sufficient funds, a user can make reservations for certain services. After a transaction is completed, his account will be increased/subtracted by a certain amount depending on if he is providing or receiving the service. On the left, the “Account Balances” button displays the account balances when clicked 1410. An user can register a bank or credit card to be used for charging or transferring money 1420. He can charge up his account 1430, withdraw money from his account 1440, check account transactions 1450, or check a service related transaction 1460. The interface can also show the history of recent activities and the amount of money involved in each transaction 1470.

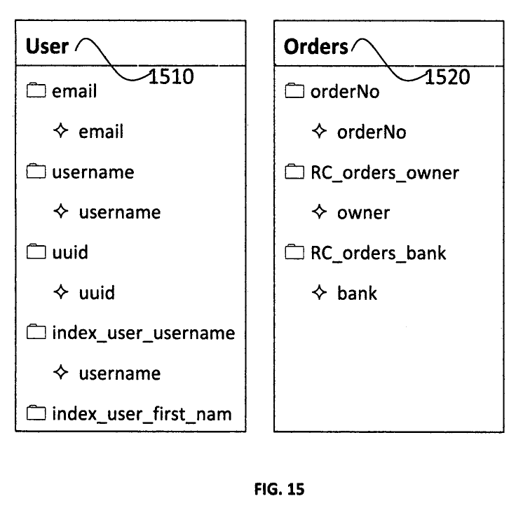

FIG. 15 shows one example of the database construct used in the system. It includes multiple tables for collecting different information, e.g., the user account table 1510, and orders table 1520.

In one embodiment, a web crawler can be used to provide for users a one-stop shop of various online services. The web crawler can search the Internet for online services. This utility may be provided alone, or together with other modules presented here. In one embodiment, the crawled information can be parsed into standard formats, e.g., one service per entry. The content can be fed into a database of online services. The service providers in this case do not have to be registered users of a certain online server, instead they can advertise on the web for their services. In this embodiment, the present invention can act more like a search engine for the web pages, but only focusing on one section of the internet web pages. In this embodiment, the information of the web page can be collected in detail and the metadata can be extracted. The collected information and metadata can be displayed in a user friendly format such as the format described above.

In one embodiment of the invention, the virtual office can be used by virtual service providers as a mean for meeting with prospective customers face-to-face and to convert these prospective customers into real customers. This utility may be provided alone, or together with other modules.

The virtual offices can be designed to simulate the real-world experiences for both virtual services providers and seekers. For example, a virtual public office or a virtual office hallway can be simulated where providers and seekers can enter freely. They can chat there, or move into a private virtual office to continue their conversation. Seekers can look at the virtual offices available, check what service each office provides, and knock on the “door” of a virtual office. The provider inside the virtual office can answer to the “knocks”, check the profile of the seeker, and make a decision on whether to allow the seeker to enter his office. A provider can also put up a sign of “Don't disturb” at his virtual office so that nobody can “knock” on the door or enter the office.

Examples of virtual providers that may use a virtual office to promote their business include: teachers, councilors, psychologists, fortune-tellers, lawyers, financial consultants, loan agents, real estate agents, tutors, universities, travel agent, immigration agents, churches, non-profit organizations, or any company having sophisticate products or services.

Virtual offices can provide clients with a world-wide presence for previously invisible or hardly visible agencies. Many service agencies are concerned about how they can be known on the internet, how they can meet more potential customers. Virtual offices provide an alternative to traditional advertisement methods. They allow users to build a stronger bound and increase the rate of converting a prospective customer into a real customer. A user no longer needs to reach to a telephone to make a call after he found the desired service online. Through virtual offices, he can do the search and chat with the service provider without using a phone. Virtual offices can also provide an advertisement format for many organizations and services. People prefer talk to people face-to-face, especially if the service is complex in nature. Using a virtual office will greatly enhance the provider's ability to explain clearly his services.

It is to be appreciated that the Detailed Description section, and not the Summary and Abstract sections, is intended to interpret the claims. The Summary and Abstract sections may set forth one or more but not all exemplary embodiments of the present invention as contemplated by the inventor, and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of providing online virtual offices to online virtual service providers to enable them to conduct services between the community of subscribers, said method comprising the steps of:
Online virtual service providers advertising their services online;
Online virtual services seekers searching the advertised services; and
The service providers and service seekers conducting online virtual services through online virtual offices.

2. the method of claim 1, further comprising the service providers advertising online the available schedule of their virtual services.

3. the method of claim 1, further comprising the service seekers booking online the advertised services

4. the method of claim 1, further comprising the service seekers paying the service providers online for the service provided.

5. the method of claim 1, further comprising the service providers conducting accounting using the tools provided online.

6. The method of claim 1, further comprising the service providers storing online information related to the service seekers and/or the services advertised or provided.

7. The method of claim 1, further comprising the service seekers storing online information related to the seekers, the service providers, or the services advertised or provided.

8. The method of claim 6, further comprising securing the said information so that only people authorized can access or edit the information.

9. The method of claim 7, further comprising securing the said information so that only people authorized can access or edit the information.

9. The method of claim 1, further comprising the service seekers rating the service providers or the service provided based on different criteria.

10. The method of claim 1, further comprising the discussing among the subscribers any topics related to the advertised services.

11. The method of claim 1, further comprising conducting virtual services through online communication format including chat room, instant message, video, or/and emails.

12. The method of claim 1, further comprising storing on the server(s) online the data related to the subscribers, the services advertised and/or provided.

13. A system for some subscribed community members to provide virtual services to other subscribed community member, the system comprising:
an online server having a registration routine for a person who has access to internet to register to the system from a local computer to become a subscriber of the system;
said online server further having a storage routine to store information related to the subscriber or the virtual service provided by the subscribers;
said online server further having an advertisement display routine to display and organize the virtual services provided by the subscribers;
said online server further having a search routine for subscribers to search the virtual services provided by the subscribers;
said online server further having a communication routine for the subscribers to conduct online virtual service in a virtual online office; and
said online server further having a client application routine, transferable via internet, allowing subscribers to access the functions of the online server.

14. A system of claim 13, wherein said online server further having a calendar routine for the virtual service providers to display their available schedule.

15. A system of claim 13, wherein said online server further having a booking routine for the subscribers to book online virtual services.

16. A system of claim 13, wherein said online server further having a payment routine for the subscribers to transfer money.

17. A system of claim 13, wherein said online server further having an accounting routine for the virtual service providers to manage their accounts online.

18. A system of claim 13, wherein said online server further having a rating routine for subscribers to rate the virtual services they have received.

19. A system of claim 13, wherein said online server further having a posting routine for subscribers to post discussion related to the virtual services provided by the subscribers.

20. A system of claim 13, wherein said communication routine using online communication format such as chat room, instant message, video, and/or emails.

21. A computer storage medium having data and instructions which will cause at least a portion of a computer system to perform the steps of claim 1.

22. A computer storage medium having data and instructions which will cause at least a portion of a computer system to perform the steps of claim 2.

23. A computer storage medium having data and instructions which will cause at least a portion of a computer system to perform the steps of claim 3.

24. A computer storage medium having data and instructions which will cause at least a portion of a computer system to perform the steps of claim 4.

25. A computer storage medium having data and instructions which will cause at least a portion of a computer system to perform the steps of claim 5.

26. A computer storage medium having data and instructions which will cause at least a portion of a computer system to perform the steps of claim 6.

27. A computer storage medium having data and instructions which will cause at least a portion of a computer system to perform the steps of claim 7.

28. A computer storage medium having data and instructions which will cause at least a portion of a computer system to perform the steps of claim 8.

29. A computer storage medium having data and instructions which will cause at least a portion of a computer system to perform the steps of claim 9.

30. A computer storage medium having data and instructions which will cause at least a portion of a computer system to perform the steps of claim 10.

31. A computer storage medium having data and instructions which will cause at least a portion of a computer system to perform the steps of claim 11.

32. A computer storage medium having data and instructions which will cause at least a portion of a computer system to perform the steps of claim 12.

33. A method of advertising on the Internet comprising:
an advertiser advertising a product or service on a web-based interface;
a customer searching the product or service advertised on the web-based interface; and
the advertiser further advertising the product or service to the customer using the virtual office facilities including web-based real-time video conference.
